(19) United States
(12) Patent Application Publication
(10) Pub. No.: US 2012/0293492 A1
(43) Pub. Date: Nov. 22, 2012

(54) INFORMATION PROCESSING SYSTEM, INFORMATION PROCESSING APPARATUS, COMPUTER-READABLE STORAGE MEDIUM HAVING INFORMATION PROCESSING PROGRAM STORED THEREIN, AND INFORMATION PROCESSING METHOD

(75) Inventors: Tomoaki KUROUME, Kyoto (JP); Tetsuya Sasaki, Kyoto (JP); Eiichi Shirakawa, Kyoto (JP)

(73) Assignee: NINTENDO CO., LTD., Kyoto (JP)

(21) Appl. No.: 13/181,778

(22) Filed: Jul. 13, 2011

(30) Foreign Application Priority Data
May 18, 2011 (JP) 2011-111892

(51) Int. Cl. G06T 15/00

(52) U.S. Cl. 345/419

(57) ABSTRACT

An information processing system includes a server for managing image files of a planar view image file format and a plurality of first information processing apparatuses each capable of transmitting/receiving an image file via the server. At least one of the first information processing apparatuses includes first transmission means for modifying metadata of an image file of a multi-view image file format which contains a multi-view image, to metadata of an image file of a planar view image file format, and transmitting the image file to the server. At least one of the first information processing apparatuses includes first display control means for, when an image file of the planar view image file format that is received from the server contains a multi-view image, performing multi-view display on a first display device by using the multi-view image.

### CROSS REFERENCE TO RELATED APPLICATION

The disclosure of Japanese Patent Application No. 2011-111892, filed on May 18, 2011, is incorporated herein by reference.

### BACKGROUND OF THE INVENTION

1. Field of the Invention

The present invention relates to an information processing system, an information processing apparatus, a computer-readable storage medium having an information processing program stored therein, and an information processing method. Specifically, the present invention relates to an information processing system, an information processing apparatus, a computer-readable storage medium having an information processing program stored therein, and an information processing method, which are related to sharing of images.

2. Description of the Background Art

Conventionally, images taken by imaging means of information terminals can be transmitted to a server. The server unifies management of the images transmitted from the information terminals, whereby a plurality of information terminals can share the images (e.g., Japanese Laid-Open Patent Publication No. 2007-249821 (hereinafter, referred to as Patent Document 1)).

However, in an example described in Patent Document 1, when a server handling images can handle only image files stored in an existing specific format, a plurality of information terminals can share only image files stored in the existing specific format. For example, when a server can handle only common formats for planar view images and cannot handle formats for stereoscopic view images, information terminals can share only planar view images via the server, and thus user's convenience cannot be improved concerning sharing of images.

Further, even if the server receives a file containing stereoscopic view image data from an information terminal and stores the file therein, another information terminal obtains the file in an imperfect state from the server. Many servers do not handle such files containing stereoscopic view image data, and thus users are in a very inconvenient situation.

### SUMMARY OF THE INVENTION

Therefore, there is a demand to provide an information processing system and the like that can improve user's convenience in such a situation.

In order to attain the object mentioned above, the present invention can be provided, as an example, in the following aspects. The following specific description is in all aspects illustrative for the understanding of the extent of the present invention, and is not intended to be limited thereto. That is, it is understood that, from the specific description, the one skilled in the art can implement the present invention in the equivalent range based on the description of the present invention and on the common technological knowledge.

In one aspect, the present invention provides an information processing system comprising a server for managing image files of a planar view image file format and a plurality of first information processing apparatuses each capable of transmitting/receiving an image file via the server. In the information processing system, at least one of the first information processing apparatuses comprises first transmission means for modifying metadata of an image file of a multi-view image file format which contains a multi-view image, to metadata of an image file of a planar view image file format, and transmitting the image file to the server. In the information processing system, at least one of the first information processing apparatuses comprises first display control means for, when an image file of the planar view image file format that is received from the server contains a multi-view image, performing multi-view display on a first display device by using the multi-view image.

In one embodiment, the first transmission means may change an extension of the image file in the metadata of the image file of the multi-view image file format to an extension for the planar view image file format, and may transmit the image file to the server.

In various embodiments, the multi-view image file format may be such a format that when the metadata of the image file of the multi-view image file format is changed to the metadata of the planar view image file format, an image among the multi-view image can be read out as a planar view image.

In various embodiments, the multi-view image file format may be a multi-picture format, and the planar view image file format may be a PEG format.

In various embodiments, the information processing system may further comprise a second information processing apparatus capable of transmitting/receiving an image file to/from the first information processing apparatuses via the server. The second information processing apparatus comprises second display control means for, even when an image file of the planar view image file format that is received from the server contains a multi-view image, performing planar-view display on a second display device by using an image among the multi-view image.

In various embodiments, the second information processing apparatus may further comprise second transmission means for transmitting an image file of the planar view image file format to the server. Further, the server may comprise: storage means for accumulatively storing the image file of the planar view image file format transmitted by the first transmission means of the first information processing apparatus and the image file of the planar view image file format transmitted by the second transmission means of the second information processing apparatus; and third transmission means for transmitting the image files stored in the storage means to the first information processing apparatus and the second information processing apparatus.

In various embodiments, the first information processing apparatus may further comprise storing means for, when an image file of the planar view image file format that is received from the server contains a multi-view image, modifying metadata of the image file to metadata of the multi-view image file format and storing the image file.

In various embodiments, the server may further comprise image processing means for performing image processing on an image indicated by an image file of the planar view image file format.

In various embodiments, the first information processing apparatus further comprises imaging means capable of performing imaging from a plurality of perspectives to take a multi-view image.

The imaging means may be capable of performing imaging from a single perspective to take a planar view image. The first transmission means may transmit, to the server, an image file of the planar view image file format that indicates the planar view image taken by the imaging means.

The information processing performed by the above information processing system is one aspect of the present invention as an information processing method. Meanwhile, a computer-readable storage medium having stored therein a program for executing the information processing performed by the above information processing system is also another aspect of the present invention.

The first information processing apparatus included in the above information processing system may be implemented as a subordinate information processing system in which a plurality of apparatuses are connected to each other. In addition, the information processing performed by the first information processing apparatus is one aspect of the present invention as an information processing method. Meanwhile, a computer-readable storage medium having stored therein a program for executing the information processing performed by the first information processing apparatus is also another aspect of the present invention.

(Terms Used Particularly in Present Specification)

As used herein, the term “computer-readable storage medium” indicates any apparatus or medium capable of storing a program, a code, and/or data to be used in a computer system. The computer-readable storage medium may be any one of a volatile device and a nonvolatile device as long as it can be read by a computer system. Examples of computer-readable storage media include a magnetic tape, a hard disc drive (HDD), a compact disc (CD), a digital versatile disc (DVD), a Blu-ray disc (BD), a semiconductor memory, but the present invention is not limited thereto.

As used herein, the term “system” (for example, a game system, or an information processing system) may include one apparatus, or may include a plurality of apparatuses each of which can communicate with another one of the apparatuses.

As used herein, a state where an apparatus or system is “connected” to another apparatus or system is not limited to a state of being connected by a line, and can include a state of being wirelessly connected.

As used herein, the term “multi-view image” refers to an image (an image group) taken from different perspectives. The (image) file of the “multi-view image file format” refers to a (image) file of a format (storing format) in which a multi-view image is recorded as one file. Examples of such a file of a multi-view image file format include, but are not limited to, a file of a “multi-picture format” described below.

As used herein, the term “individual image” refers to still image data defined in a predetermined area in image data. Specifically, when the predetermined area is an area delimited by a set of SOT-EOI markers of JPEG compliant data specified in Exif specification, the “individual image” is still image data, in the area, excluding data in APPn.

As used herein, the term “APPn” refers to a JPEG (Joint Photographic Experts Group) application marker segment which Exif specification refers to.

As used herein, the “(computer) file” is a logical unit for storing any data.

As used herein, the “file format” is a specific mode in which information is encoded for storing the information in a computer file. The computer file is a group of any information or a resource having information stored therein, which can be used by a computer program.

As used herein, the “file name” is a name (identification symbol) for identifying a file stored in a file system of a computer. In addition, as used herein, the “extension” refers to a character string for identifying the type of a file which character string is assigned to a part (typically, the end) of a file name.

As used herein, the term “metadata” refers to additional data concerning target data, which is included in the target data. When the term “metadata” is used for image data included in an image file, the metadata can include the file name of the image file holding the image data.

As used herein, the term “modified multi-view image file format file” refers to a file that is obtained by modifying metadata of a multi-view image file format file and that can be recognized by a specific computer system as being in a planar view image file format while having a recording mode as a multi-view image file format. in addition, the modified multi-view image file format file can be a file that can be identified as being in a planar view image file format by a specific computer system without changing a state of recording a multi-view image. Typically, one example of the “modified multi-view image file format file” includes a “modified multi-picture format file” or an image file which is in the data recording format of the multi-picture format file while having the extension of its filename modified from its original one (e.g., .MPO) to another one (e.g., .JPG) which indicates another data recording format.

Further, when a modified multi-view image file format file is generated from a multi-view image file format file (stereoscopic view image file) containing a below-described “stereoscopic view image” that is a kind of a multi-view image, the modified multi-view image file format file is particularly referred to as “modified stereoscopic view image file”.

As used herein, the “stereoscopic view” is one function of human binocular vision. Specifically, the “stereoscopic view” refers to a function of obtaining a sense of depth from a difference between retinal images of both eyes.

As used herein, the “stereoscopic view image” refers to an image or image group that has a characteristic of being perceived as a stereoscopically visible image with a sense of depth by an observer in a state where the image is visibly provided (e.g., the image has a characteristic of reflecting a binocular disparity). For example, the “stereoscopic view image” refers to an image that provides a sense of depth to an observer when the observer views the image from a specific direction. When exemplified, the “stereoscopic view image” can be represented as a collection of density values provided to points in a space that is defined by three coordinate axes that are two free space coordinate axes and one spatial axis which corresponds to the specific direction.

Specifically, the stereoscopic view image includes at least one pair of a portion (an image for a right eye) to be viewed by the right eye of an observer of the image and a portion (an image for a left eye) to be viewed by the left eye of the observer of the image. Typically, the stereoscopic view image can be provided in a predetermined format including images taken from a plurality of different viewpoints. As a format for providing a stereoscopic view image, an image for a left eye and an image for a right eye may be stored as an image (one file) including these images arranged side by side. In addition, the stereoscopic view image may be provided in a predetermined format in which additional information is provided as necessary to information corresponding to these individual images. For example, examples of a format for providing a stereoscopic view image include, but are not limited to, the multi-picture format described above.

It should be noted that the stereoscopic view image may be composed of an image or image group having a structure in which a portion serving as an image for a left eye and a portion serving as an image for a right eye are divided and rearranged as appropriate according to the properties of a display device to be used. For example, the stereoscopic view image may be provided in a form where an image for a left eye and an image for a right eye that are generated as separate images are divided into aligned rectangle-shaped images each having one line of pixels in the vertical direction.

As described above, the stereoscopic view image can be in any form as long as the stereoscopic view image has a function to provide a characteristic of being perceived as a stereoscopically visible image with a sense of depth by an observer.

When the individual images constituting the stereoscopic view image are provided as still image data, the still image data can be provided in any digital image format. Examples of major file formats capable of handling still images include, but are not limited to, JPEG (Joint Photographic Experts Group).

As used herein, the “stereoscopic display” refers to a device that displays a video image that is stereoscopically viewed by an observer or a video image (image) from which an observer obtains a sense of depth. Specifically, examples of the stereoscopic display include an autostereoscopic display and an eyeglasses type stereoscopic display. Examples of the autostereoscopic display include, but are not limited to, a parallax barrier type stereoscopic display device and a lenticular lens type display device.

As used herein, “performing multi-view display” on an image display device is to visibly provide an image file of a format that can support multi-view images, to the user of the display device according to specifications of the file, with a predetermined effect of the multi-view images. For example, when a multi-view image is a stereoscopic view image, the image display device performing multi-view display of the images means to display the multi-view image in a stereoscopically visible manner to the user.

As used herein, the “planar view” is a visual function that is not based on stereoscopic view. In addition, the “planar view image” is an image that is neither a stereoscopic view image nor any other multi-view image, and is typically an image that can be provided in the form of still image data. Further, the “planar view image file format” is an image data recording mode that supports recoding of a planar view image, and examples thereof include, but are not limited to, a PEG format.

As used herein, the “display device” for “planar view” refers to a display device that does not have a stereoscopic display function, or a display device that is in a state where a stereoscopic display function is selectively inactivated.

The present invention can improve, for example, convenience of a user handling a stereoscopic view image via a computer network.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically illustrating an information processing system according to an exemplified embodiment of the present invention;

FIG. 2 is a plan view of an outer appearance of a game apparatus 3;

FIG. 3 is a block diagram illustrating an internal configuration of the game apparatus 3;

FIG. 4 is a diagram illustrating a memory map of a main memory 32 of the game apparatus 3;

FIG. 5A is a flowchart illustrating an example of a main process performed on the basis of an information processing program in the game apparatus 3 according to the exemplified embodiment of the present invention;

FIG. 5B is a flowchart illustrating an exemplified image sharing preparation process; and

FIG. 5C is a flowchart illustrating an example of a process performed when the game apparatus 3 obtains an image file from a web server 4.

### DESCRIPTION OF THE PREFERRED EMBODIMENTS

(Outline of the Invention)

In an exemplified embodiment, the present invention provides an information processing system including an information processing apparatus (e.g., an information processing terminal, a hand-held game apparatus, or the like, hereinafter, referred to as a first information processing apparatus for the convenience sake) that is communicable with a web server that can manage planar view images. The web server is communicable with another information processing apparatus (e.g., a general-purpose computer, an information processing terminal, or the like, hereinafter, referred to as a second information processing apparatus for the convenience sake). Here, each of these information processing apparatuses is at least connectable to the web server via a computer network. The computer network typically refers to a computer network that provides mutual connection by using Internet protocol technology.

The information processing system is in one form of a distributed computing based system. In other words, each portion of a program group executed in the information processing system is executed simultaneously in parallel by a plurality of computers (e.g., the above first and second information processing apparatuses, a computer included in the web server), and these computers communicate with each other via the computer network as necessary.

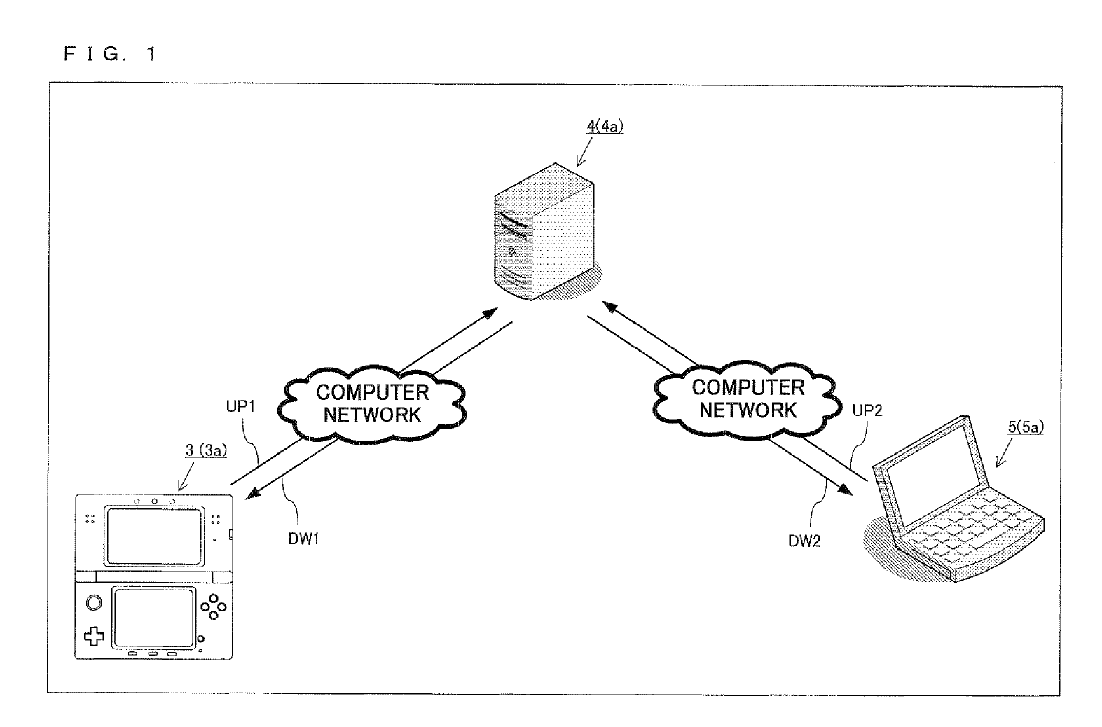

Specifically, the information processing system is provided as an exemplified information processing system shown in FIG. 1. FIG. 1 is a diagram schematically illustrating the information processing system according to the exemplified embodiment of the present invention.

FIG. 1 shows a game apparatus 3, a web server 4 for managing planar view images, and a general-purpose computer 5 as the exemplified first information processing apparatus, web server, and second information processing apparatus, respectively. In this example, for the convenience sake, the game apparatus 3, the web server 4, the general-purpose computer 5 are shown as one game apparatus 3a, one web server 4a, and one general-purpose computer 5a, respectively. However, in addition to the game apparatus 3a, the web server 4a, and the general-purpose computer 5a, the exemplified information processing system may include any of or one or more combinations of a game apparatus, a web server, and a general-purpose computer (e.g., a game apparatus 3b, a web server 4b, and a general-purpose computer 5b) that are substantially the same as them.

(Game Apparatus 3; Information Processing Apparatus Having a Function to Display a Stereoscopic View Image)

The game apparatus 3 is an example of an information processing apparatus having a function to display a stereoscopic view image.

(Exemplified Structure of Game Apparatus 3)

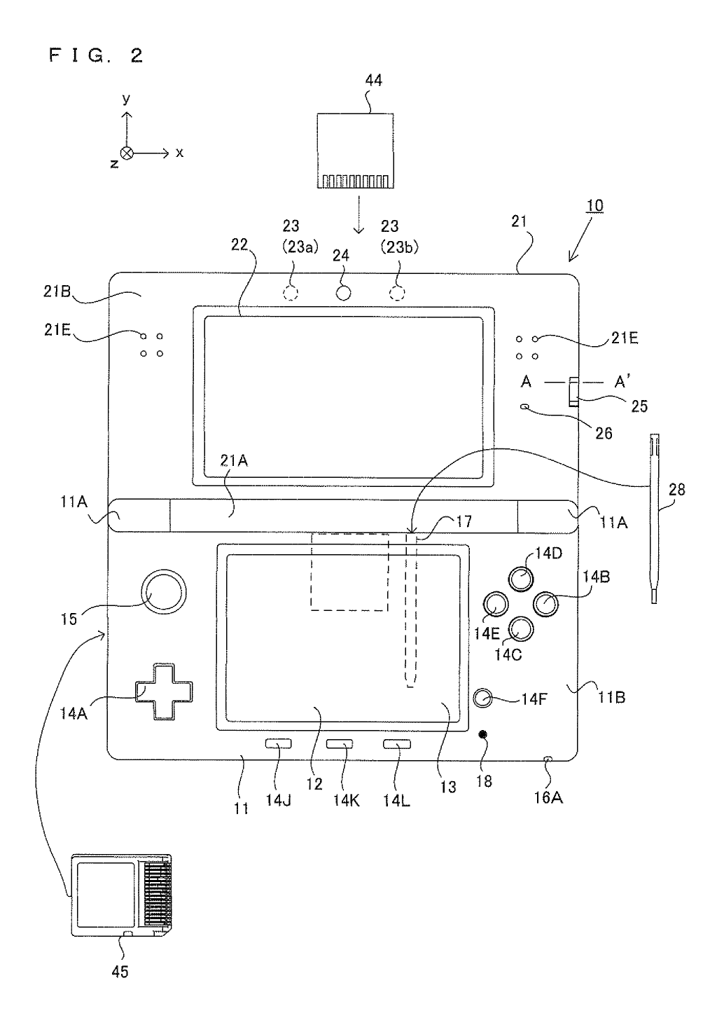

Hereinafter, the game apparatus 3 according to the exemplified embodiment of the present invention will be described. FIG. 2 is a plan view of an outer appearance of the game apparatus 3. The game apparatus 3 is a hand-held game apparatus, and is configured to be foldable. FIG. 2 (and the drawing shown in the lower left portion of FIG. 1) shows the game apparatus 3 in an opened state. Specifically, FIG. 2 is a front view of the game apparatus 3 in the opened state. A side view of the game apparatus 3 is omitted.

The game apparatus 3 is able to take an image by means of an imaging section, display the taken image on a screen, and store data of the taken image. The game apparatus 3 can execute a game program which is stored in an detachable memory card (e.g., a below-described external memory 44) or a game program which is received from a server or another game apparatus or stored in a built-in storage area (e.g., a below-described internal data storage memory 35), and can display, on the screen, an image generated by computer graphics processing, such as an image taken by a virtual camera set in a virtual space, for example.

(External Structure of Game Apparatus 3)

An external structure of the game apparatus 3 will be described in more detail with reference to FIG. 2. The game apparatus 3 includes a lower housing 11 and an upper housing 21 as shown in FIG. 2. The lower housing 11 and the upper housing 21 are connected to each other so as to be openable and closable (foldable).

(Description of Lower Housing)

Initially, a structure of the lower housing 11 will be described. As shown in FIG. 2, in the lower housing 11, a lower LCD (Liquid Crystal Display) 12, a touch panel 13, operation buttons 14A to 14L, an analog stick 15, an LED 16A and an LED 16B, an insertion opening 17, and a microphone hole 18 are provided.

As shown in FIG. 2, the lower LCD 12 is accommodated in the lower housing 11. The number of pixels of the lower LCD 12 may be, for example, 320 dots×240 dots (the longitudinal line×the vertical line). The lower LCD 12 is a display device for displaying an image in a planar manner (not in a stereoscopically visible manner), which is different from the upper LCD 22 as described below. Although an LCD is used as a display device in the present embodiment, any other display device such as a display device using an EL (Electro Luminescence), or the like may be used. In addition, a display device having any resolution may be used as the lower LCD 12.

As shown in FIG. 2, the game apparatus 3 includes the touch panel 13 as an input device. The touch panel 13 is mounted on the screen of the lower LCD 12. In the present embodiment, the touch panel 13 may be, but is not limited to, a resistive film type touch panel.

The operation buttons 14A to 14L are each an input device for making a predetermined input.

The analog stick 15 is a device for indicating a direction. The analog stick 15 has a top, corresponding to a key, which slides parallel to the inner side surface of the lower housing 11. The analog stick 15 acts in accordance with a program executed by the game apparatus 3.

The game apparatus 3 has a function of connecting to a wireless LAN in a method based on, for example, IEEE802.11.b/g standard.

(Description of Upper Housing)

Next, a structure of the upper housing 21 will be described. As shown in FIG. 2, in the upper housing 21, an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26 are provided.

As shown in FIG. 2, the upper LCD 22 is accommodated in the upper housing 21. The number of pixels of the upper LCD 22 may be, for example, 800 dots×240 dots (the horizontal line×the vertical line). Although, in the present embodiment, the upper LCD 22 is an LCD, a display device using an EL (Electro Luminescence), or the like may be used. In addition, a display device having any resolution may be used as the upper LCD 22.

The upper LCD 22 is a display device capable of displaying a stereoscopically visible image. Further, in the present embodiment, an image for a left eye and an image for a right eye are displayed by using substantially the same display area. Specifically, the upper LCD 22 may be a display device using a method in which the image for a left eye and the image for a right eye are alternately displayed in the horizontal direction in predetermined units (for example, every other line). Further, in the present embodiment, the upper LCD 22 is a display device capable of displaying an image which is stereoscopically visible with naked eyes. A lenticular lens type display device or a parallax barrier type display device is used which enables the image for a left eye and the image for a right eye, which are alternately displayed in the horizontal direction, to be separately viewed by the left eye and the right eye, respectively.

In the present embodiment, the upper LCD 22 of a parallax barrier type is used. The upper LCD 22 displays, by using the image for a right eye and the image for a left eye, an image (a stereoscopic view image) which is stereoscopically visible with naked eyes. That is, the upper LCD 22 allows a user to view the image for a left eye with her/his left eye, and the image for a right eye with her/his right eye by utilizing a parallax barrier, so that a stereoscopic view image (a stereoscopically visible image) exerting a stereoscopic effect for a user can be displayed. Further, the upper LCD 22 may disable the parallax barrier. When the parallax barrier is disabled, an image can be displayed in a planar manner (it is possible to display a planar visible image which is different from a stereoscopically visible image as described above. Specifically, a display mode is used in which the same displayed image is viewed with a left eye and a right eye.). Thus, the upper LCD 22 is a display device capable of switching between a stereoscopic display mode for displaying a stereoscopically visible image and a planar display mode (for displaying a planar view image) for displaying an image in a planar manner. The switching of the display mode is performed by the 3D adjustment switch 25 described below.

Two imaging sections (23a and 23b) provided on the outer side surface (the back surface reverse of the main surface on which the upper LCD 22 is provided) 21D of the upper housing 21 are generically referred to as the outer imaging section 23. The imaging directions of the outer imaging section (left) 23a and the outer imaging section (right) 23b are each the same as the outward normal direction of the outer side surface 21D. The outer imaging section (left) 23a and the outer imaging section (right) 23b can be used as a stereo camera depending on a program executed by the game apparatus 3. Each of the outer imaging section (left) 23a and the outer imaging section (right) 23b includes an imaging device, such as a CCD image sensor or a CMOS image sensor, having a common predetermined resolution, and a lens.

The inner imaging section 24 is positioned on the inner side surface (main surface) 21B of the upper housing 21, and acts as an imaging section which has an imaging direction which is the same direction as the inward normal direction of the inner side surface. The inner imaging section 24 includes an imaging device, such as a CCD image sensor and a CMOS image sensor, having a predetermined resolution, and a lens.

The 3D adjustment switch 25 is a slide switch, and is used for switching a display mode of the upper LCD 22 as described above. Further, the 3D adjustment switch 25 is used for adjusting the stereoscopic effect of a stereoscopically visible image (stereoscopic view image) which is displayed on the upper LCD 22. A slider 25a of the 3D adjustment switch 25 is slidable to any position in a predetermined direction (along the longitudinal direction of the right side surface), and a display mode of the upper LCD 22 is determined in accordance with the position of the slider 25a. Further, a manner in which the stereoscopic view image is visible is adjusted in accordance with the position of the slider 25a. Specifically, an amount of deviation in the horizontal direction between a position of an image for a right eye and a position of an image for a left eye is adjusted in accordance with the position of the slider 25a.

The 3D indicator 26 indicates whether or not the upper LCD 22 is in the stereoscopic display mode. The 3D indicator 26 is implemented as a LED, and is lit up when the stereoscopic display mode of the upper LCD 22 is enabled. The 3D indicator 26 may be configured to be lit up only when the upper LCD 22 is in the stereoscopic display mode and program processing for displaying a stereoscopic view image is performed.

Further, a speaker hole 21E is provided on the inner side surface of the upper housing 21. A sound is outputted through the speaker hole 21E from a speaker 43 described below.

(Internal Configuration of Game Apparatus 3)

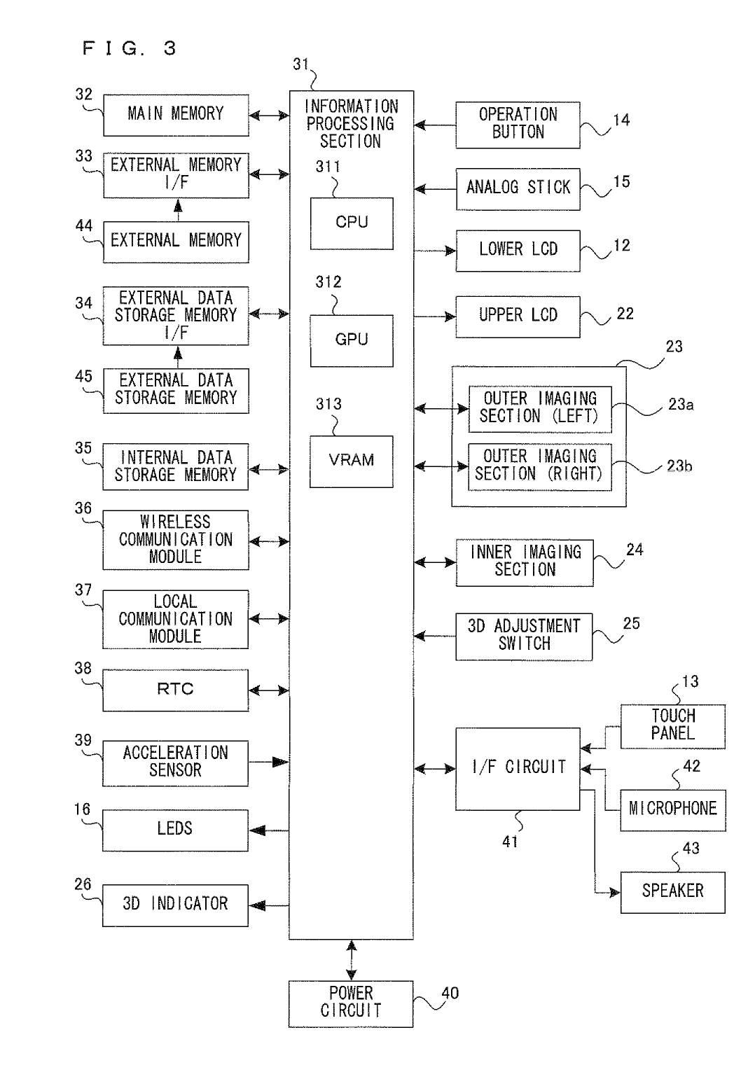

Next, an internal electrical configuration of the game apparatus 3 will be described with reference to FIG. 3. FIG. 3 is a block diagram illustrating an internal configuration of the game apparatus 3. As shown in FIG. 3, the game apparatus 3 includes, in addition to the components described above, electronic components such as an information processing section 31, a main memory 32, an external memory interface (external memory I/F) 33, an external data storage memory I/F 34, the internal data storage memory 35, a wireless communication module 36, a local communication module 37, a real-time clock (RTC) 38, an acceleration sensor 39, a power supply circuit 40, an interface circuit (I/F circuit) 41, and the like. These electronic components are mounted on an electronic circuit substrate, and accommodated in the lower housing 11 (or the upper housing 21).

The information processing section 31 is information processing means which includes a CPU (Central Processing Unit) 311 for executing a predetermined program, a GPU (Graphics Processing Unit) 312 for performing image processing, and the like. The CPU 311 of the information processing section 31 executes a program stored in a memory (for example, the external memory 44 connected to the external memory I/F 33 or the internal data storage memory 35) inside the game apparatus 3, thereby performing processing corresponding to the program (e.g., photographing processing and below-described game processing). The program executed by the CPU 311 of the information processing section 31 may be obtained from another device through communication with the other device. The information processing section 31 further includes a VRAM (Video RAM) 313. The GPU 312 of the information processing section 31 generates an image in accordance with an instruction from the CPU 311, and renders the image in the VRAM 313. The GPU 312 outputs the image rendered in the VRAM 313, to the upper LCD 22 and/or the lower LCD 12, and the image is displayed on the upper LCD 22 and/or the lower LCD 12.

To the information processing section 31, the main memory 32, the external memory I/F 33, the external data storage memory I/F 34, and the internal data storage memory 35 are connected. The external memory I/F 33 is an interface for detachably connecting to the external memory 44. The external data storage memory I/F 34 is an interface for detachably connecting to the external data storage memory 45.

The main memory 32 is volatile storage means used as a work area and a buffer area for (the CPU 311 of) the information processing section 31. That is, the main memory 32 temporarily stores various types of data used for the processing based on the above program, and temporarily stores a program obtained from the outside (the external memory 44, another device, or the like), for example. In the present embodiment, for example, a PSRAM (Pseudo-SRAM) is used as the main memory 32.

The external memory 44 is nonvolatile storage means for storing a program executed by the information processing section 31. The external memory 44 is implemented as, for example, a read-only semiconductor memory. When the external memory 44 is connected to the external memory I/F 33, the information processing section 31 can load a program stored in the external memory 44. A predetermined process is performed by the program loaded by the information processing section 31 being executed. The external data storage memory 45 is implemented as a non-volatile readable and writable memory (for example, a NAND flash memory), and is used for storing predetermined data. For example, images taken by the outer imaging section 23 and/or images taken by another device are stored in the external data storage memory 45. When the external data storage memory 45 is connected to the external data storage memory I/F 34, the information processing section 31 loads an image stored in the external data storage memory 45, and the image can be displayed on the upper LCD 22 and/or the lower LCD 12.

The internal data storage memory 35 is implemented as a non-volatile readable and writable memory (for example, a NAND flash memory), and is used for storing predetermined data. For example, data and/or programs downloaded through the wireless communication module 36 by wireless communication is stored in the internal data storage memory 35.

The wireless communication module 36 has a function of connecting to a wireless LAN by using a method based on, for example, IEEE 802.11.b/g standard. The local communication module 37 has a function of performing wireless communication with the same type of game apparatus in a predetermined communication method (for example, infrared communication). The wireless communication module 36 and the local communication module 37 are connected to the information processing section 31. The information processing section 31 can perform data transmission to and data reception from another device via the Internet by using the wireless communication module 36, and can perform data transmission to and data reception from the same type of another game apparatus by using the local communication module 37.

The acceleration sensor 39 is connected to the information processing section 31. In addition, the RTC 38 and the power supply circuit 40 are connected to the information processing section 31. The RTC 38 counts time, and outputs the time to the information processing section 31. The information processing section 31 calculates a current time (date) based on the time counted by the RTC 38. The power supply circuit 40 controls power from the power supply (the rechargeable battery accommodated in the lower housing 11 as described above) of the game apparatus 3, and supplies power to each component of the game apparatus 3.

The I/F circuit 41 is connected to the information processing section 31. The microphone 42 and the speaker 43 are connected to the I/F circuit 41.

The operation button 14 includes the operation buttons 14A to 14L described above, and is connected to the information processing section 31. Operation data representing an input state of each of the operation buttons 14A to 14I is outputted from the operation button 14 to the information processing section 31, and the input state indicates whether or not each of the operation buttons 14A to 14I has been pressed. The information processing section 31 obtains the operation data from the operation button 14 to perform a process in accordance with the input on the operation button 14.

The lower LCD 12 and the upper LCD 22 are connected to the information processing section 31. The lower LCD 12 and the upper LCD 22 each display an image in accordance with an instruction from (the GPU 312 of) the information processing section 31. In the present embodiment, the information processing section 31 causes the upper LCD 12 to display a stereoscopic view image (stereoscopically visible image).

Specifically, the information processing section 31 is connected to an LCD controller (not shown) of the upper LCD 22, and causes the LCD controller to set the parallax barrier to ON or OFF. When the parallax barrier is set to ON in the upper LCD 22, an image for a right eye and an image for a left eye which are stored in the VRAM 313 of the information processing section 31 are outputted to the upper LCD 22. More specifically, the LCD controller alternately repeats reading of pixel data of the image for a right eye for one line in the vertical direction, and reading of pixel data of the image for a left eye for one line in the vertical direction, thereby reading, from the VRAM 313, the image for a right eye and the image for a left eye. Thus, an image to be displayed is divided into the images for a right eye and the images for a left eye each of which is a rectangle-shaped image having one line of pixels aligned in the vertical direction, and an image, in which the rectangle-shaped image for the left eye which is obtained through the division, and the rectangle-shaped image for the right eye which is obtained through the division are alternately aligned, is displayed on the screen of the upper LCD 22. A user views the images through the parallax barrier in the upper LCD 22, so that the image for the right eye is viewed by the user's right eye, and the image for the left eye is viewed by the user's left eye. Thus, the stereoscopically visible image is displayed on the screen of the upper LCD 22.

The outer imaging section 23 and the inner imaging section 24 are connected to the information processing section 31. The outer imaging section 23 and the inner imaging section 24 each take an image of a real space in accordance with an instruction from the information processing section 31 and output image data of the real space to the information processing section 31.

The 3D adjustment switch 25 is connected to the information processing section 31. The 3D adjustment switch 25 transmits, to the information processing section 31, an electrical signal in accordance with the position of the slider 25a.

The 3D indicator 26 is connected to the information processing section 31. The information processing section 31 controls whether or not the 3D indicator 26 is to be lit up.

(One Example of Web Browser Application Included in Game Apparatus 3)

The game apparatus 3 has a web browser application 71 (hereinafter, referred to as web browser 71). The web browser 71 has, as basic functions, for example, functions of an HTTP user agent, a parser, and a renderer. The HTTP user agent is a program that communicates with a web server on the basis of URI•HTTP or the like to obtain a resource. The parser is a program that performs parsing in accordance with the obtained resource (text, image, HTML, XHTML, XML, or the like). The renderer is a program that shows a user the resource in an appropriate form on the basis of a result of the parsing by the parser. For example, the renderer shows the user the resource in a form in which an image and a text are arranged on a display screen on the basis of a predetermined arrangement.

Specifically, for example, the web browser 71 can be one conforming to, for example, OMA Browsing 2.3 standards as supporting standards. In addition, examples of a protocol included in the web browser 71 include, but are not limited to, HTTP 1.0/1.1, WAP, IPv4/IPv6, and Dual TCP/IP.

Further, examples of a script included in the web browser 71 include, but are not limited to, ECMAScript 262 3rd Edition, ECMAScript Mobile Profile, WMLScript, DOM Level 1, Level 2, Dynamic HTML, and Ajax (XMLHttpRequest).

Examples of a markup included in the web browser 71 include, but are not limited to, eHTML, HTML5, HTML 4.01, XHTML1.1, XHTML Mobile Profile 1.2, WML 1.3, and SMIL 2.1 (RSS 0.9/0.91/0.92/1.0/2.0, Atom 0.3/1.0).

Examples of a style sheet included in the web browser 71 include, but are not limited to, CSS1, CSS2.1, CSS3, and CSS MP1.1.

(Program That Generates Modified Multi-View Image File Format File)

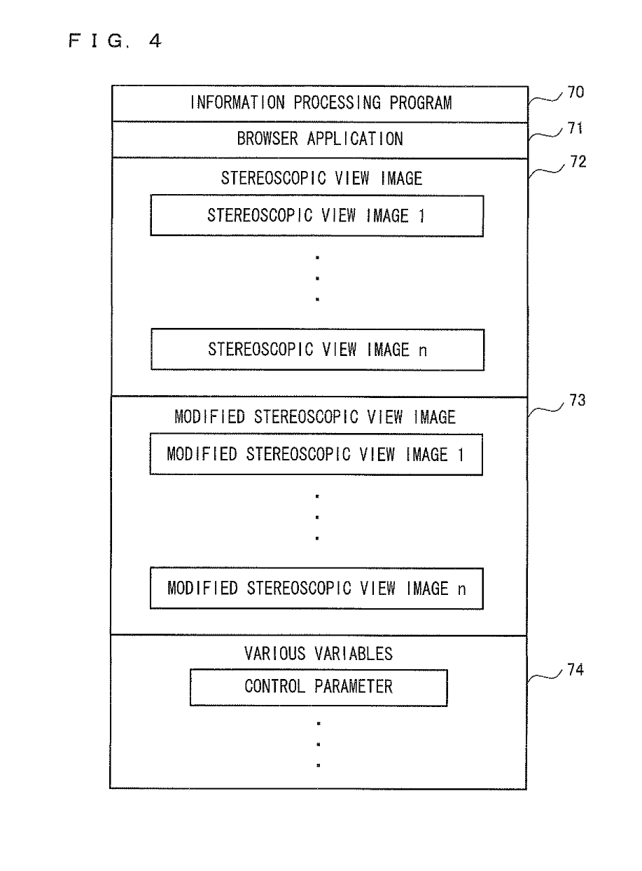

The game apparatus 3 has a program that provides a multi-view image file format file (e.g., a multi-picture format file) as a modified multi-view image file format file that is handled as a planar view image file format (e.g., JPEG format) by the web server 4, which manages planar view images, while maintaining a substantial data structure (recording mode) of a file format unique to the multi-view image file format file. Specifically, the program that generates a modified multi-view image file format file may be executed as an independent program (e.g., an information processing program 70 (see FIG. 4)) or a part thereof according to a request from a program of the above web browser 71 or another game apparatus 3. In addition, the program that generates a modified multi-view image file format file may be incorporated into the above web browser 71.

(Transmission/Reception of Image File Between Game Apparatus 3 and Web Server 4 [1])

The game apparatus 3 can upload a modified multi-view image file format file to the web server 4, for example, by the function of the above web browser 71 (the reference character UP1 in FIG. 1).

Here, the web server 4 has stored therein not only modified multi-view image file format files transmitted by another game apparatus 3 (e.g., the game apparatus 3b) but also planar view image files transmitted by the general-purpose computer 5 and the like. The game apparatus 3 transmits a request to the web server 4, and has means for determining whether or not an image file received from the web server 4 is the modified multi-view image file format file. A criterion for this determination will be described in detail below. When a result of the determination is positive, the game apparatus 3 can display the received image file on a first display device that can perform reproduction in a form in which a function of a multi-view image file format file is used (e.g., in a stereoscopically visible form).

(One Example of Camera Application and the Like Included in Game Apparatus 3)

The game apparatus 3 includes a stereo camera. Specifically, the game apparatus 3 includes an optical system that can serve as a stereo camera, for example, an outer imaging section 23a for a left eye and an outer imaging section 23b for a right eye. The game apparatus 3 can generate a stereoscopic view image taken by the stereo camera (an image group in which a binocular disparity is reflected). The game apparatus 3 can store the generated stereoscopic view image as a file of a predetermined format supporting multi-view images (e.g., a multi-picture format), in a storage area of the game apparatus 3.

The game apparatus 3 modifies a multi-view image format (e.g., a stereoscopic view image format) file containing a multi-view image taken by the stereo camera to a modified multi-view image file format file (a modified stereoscopic view image file). Specifically, the game apparatus 3 performs a process, by a program, of generating the above modified multi-view image file format file from the multi-view image file format file. More specifically, for example, the game apparatus 3 changes the extension of a file of a multi-picture format (i.e., .MPO) in the file name to the extension of a JPEG format, while maintaining a recorded content in accordance with this format. It should be noted that when changing the extension, the game apparatus 3 may change the extension of a processing target file (a file whose extension is .MPO) present in the storage area, but may copy the processing target file and perform the changing process on the copied file.

It should be noted that the game apparatus 3 can also cause the outer imaging section 23 to serve as a monocular camera for generating a planar view image file (e.g., a JPEG format file), not a stereoscopic view image file.

Further, in addition to causing the outer imaging section 23 to serve as a stereo camera to generate a stereoscopic view image, the game apparatus 3 may generate a stereoscopic view image, for example, by storing, as a stereoscopically visible screen shot, a stereoscopically visible game image displayed on the upper LCD 22. The screen shot may be generated, for example, by setting a virtual stereo camera in a virtual space and generating a stereoscopic view image (an image for a right eye and an image for a left eye) of a subspace (a partial virtual space including a virtual object) to be displayed on a display screen.

(Exemplary Structure of Web Server 4)

The web server 4 can provide a web site for sharing images among a plurality of users. The web site handles still image files of conventionally and commonly used file formats (e.g., JPEG format image files) but does not handle files of file formats (e.g., multi-picture format files) supporting multi-view images (e.g., stereoscopic view images).

The web server 4 manages image files of planar view image file formats. Thus, the web server 4 can provide a web site supporting image files of planar view image file formats (e.g., a web site that provides an image list including thumbnails for sharing planar view images). In the conventional art, such a web server has various problems concerning sharing of images when receiving a multi-view image file format file such as a multi-picture format file. For example, some servers face a problem that they automatically discard some of individual images included in a multi-picture format file, e.g. a server discards all the individual images other than the first individual image

(Transmission/Reception of Image File Between Game Apparatus 3 and Web Server 4 [2])

Even in such a case, the game apparatus 3 (e.g., the game apparatus 3a) according to the exemplified embodiment of the present invention uploads, to the web server 4, a modified multi-view image file format file (e.g., a modified multi-picture format file obtained by assigning a JPEG extension while maintaining a substantial structure as a multi-picture format), and the modified multi-view image file format file can be shared by another game apparatus 3 (e.g., the game apparatus 3b) or the general-purpose computer 5 described below.

In the example described above, when downloading a modified multi-view image file format file from the web server 4, the game apparatus 3b determines whether or not the modified multi-view image file format file includes a data content corresponding to the multi-view image file format file, from not only its extension but also other information.

For example, the game apparatus 3b regards an image file downloaded from the web server 4 as a multi-picture format file, and starts analysis. In one example, the game apparatus 3b can determine whether or not the image file includes any individual image in addition to the first individual image in the multi-picture format. By so doing, the game apparatus 3b can determine whether or not the downloaded image file is a multi-picture format file as an entity. In another example, the game apparatus 3b reads a portion at a position, in the downloaded image file, corresponding to additional information (e.g., a file header, individual image type management information, or the like) of the multi-picture format. Then, for example, when the game apparatus 3b determines, from the information at the position, that the image file includes information of a multi-view image (e.g., a stereoscopic view image), the game apparatus 3b can determine that the image file is a modified multi-view image file format file (a modified stereoscopic view image file). Thus, for example, even after obtaining, via the web server 4, an image file that is handled as a stereoscopic view image file in the game apparatus 3a, the game apparatus 3b can similarly handle the image file as a stereoscopic view image file. In other words, the web server 4 and the like regard the modified multi-view image file format file as a planar view image file (a PEG file in the example described above), but the game apparatus 3 (the game apparatuses 3a and 3b) handles the modified multi-view image file format file as a file in which the function of a multi-view image file format file is maintained.

When the game apparatus 3 or general-purpose computer 5 (described below) is connected to the web server 4 via the computer network and accesses data constructing a web site, the game apparatus 3 or general-purpose computer 5 can obtain a set of data for displaying an image list held in the web server 4, e.g., as set of data for constructing the web site.

Specifically, the general-purpose computer 5 creates thumbnails from the set of data including stored images, and displays an image list on a display device by using the thumbnails. When one displayed thumbnail is selected by the user, an original image corresponding to the selected thumbnail can be displayed on the display device.

(Exemplary Structure of General-Purpose Computer 5)

The general-purpose computer 5 can establish a state of being connected to the web server 4 via the computer network. Typically, the general-purpose computer 5 does not include a display device capable of providing a stereoscopic view. The general-purpose computer 5 can upload a planar view image file to the web server 4 via the computer network (the reference character UP2 in FIG. 1). In addition, the general-purpose computer 5 can upload a planar view image file or a modified multi-view image file format file to the web server 4 via the computer network (the reference character UP2 in FIG. 1).

The general-purpose computer 5 further includes second display control means for, regardless of whether an image file (see the reference character DW2 in FIG. 1) received from the above web server 4 is the modified multi-view image file format file or the planar view image file, performing planar-view display of an image of the modified multi-view image file format file or the planar view image file on a second display device.

In an exemplified embodiment, for example, each of a modified multi-picture format file and a planar view image file exists with a file name having an extension corresponding to one of JPEG format files. A data recording format held by the modified multi-picture format file has the same type of format as that in the multi-view image file format file. However, the general-purpose computer 5 can handle, as a planar view image, the first individual image among individual images included in a modified multi-picture format file having a JPEG extension (.JPG or the like) in its file name. Thus, regardless of whether a handled image file is a modified multi-picture format file or a planar view image file, the general-purpose computer 5 can display their images on a display device for planar view.

(One Example of Effect Provided in Exemplified Embodiment)

As described above, according to the exemplified embodiment of the present invention, even after multi-view images (e.g., stereoscopic view images) are transmitted/received between the game apparatus 3 (e.g., the game apparatus 3a) and a game apparatus of the same type (e.g., the game apparatus 3b) via the web server 4 that does not support handling of multi-view images, the content of the multi-view images can appropriately be shared by the game apparatus 3 and the game apparatus of the same type. In other words, the game apparatus 3a can substantially share multi-view images (e.g., stereoscopic view images) with another game apparatus 3b via the web server 4, which does not support handling of stereoscopic view images, and/or the general-purpose computer 5. The web server 4 can handle a modified multi-view image file format file similarly to a general planar view image file, and in the game apparatus 3, such a modified multi-view image file format file as a file containing a multi-view image (e.g., a stereoscopic view image) can provide a stereoscopic view to the user. In this manner, the user of the game apparatus 3a can share, for example, a stereoscopic view image file with another game apparatus 3 (the game apparatus 3b) via the web server 4 without depending on whether or not the web server 4 supports handling of stereoscopic view images.

(Detailed Process Flow)

(Exemplified Process)

Hereinafter, a flow of a process performed on the basis of an information processing program according to the exemplified embodiment of the present invention will be described with reference to flowcharts in the appended drawings. In the appended drawings, “step” is abbreviated to “S”. It should be noted that the flowcharts in the appended drawings are merely examples of a processing procedure. Therefore, the order of each process step may be changed as long as the same result is obtained. In addition, the values of variables and thresholds used at determination steps are also merely examples, and other values may be used as necessary.

Hereinafter, an example of specific processes performed by the information processing program according to the exemplified embodiment of the present invention will be described with reference to the appended drawings. As shown in FIG. 1, the exemplified embodiment includes the system including the game apparatus 3, the web server 4, and the general-purpose computer 5.

(Memory Map)

First, main data stored in the main memory 32 during execution of the information processing program according to the present embodiment will be described. FIG. 4 is a diagram illustrating a memory map of the main memory 32 of the game apparatus 3. As shown in FIG. 4, the information processing program 70, the web browser application 71, stereoscopic view images 72, modified stereoscopic view images 73, various variables 74, and the like are stored in the main memory 32. Unless otherwise specified herein, each parameter is stored in the main memory 32 of the game apparatus 3 and can be reused. Alternatively, data indicating these parameters and the like may be stored in another storage area of the game apparatus 3 and may be reused by being read therefrom.

(Process in Game Apparatus 3)

(Upload from Game Apparatus 3 to Web Server 4) Hereinafter, information processing mainly performed in the game apparatus 3, among information processing performed in the information processing system shown in FIG. 1, will be described in detail.

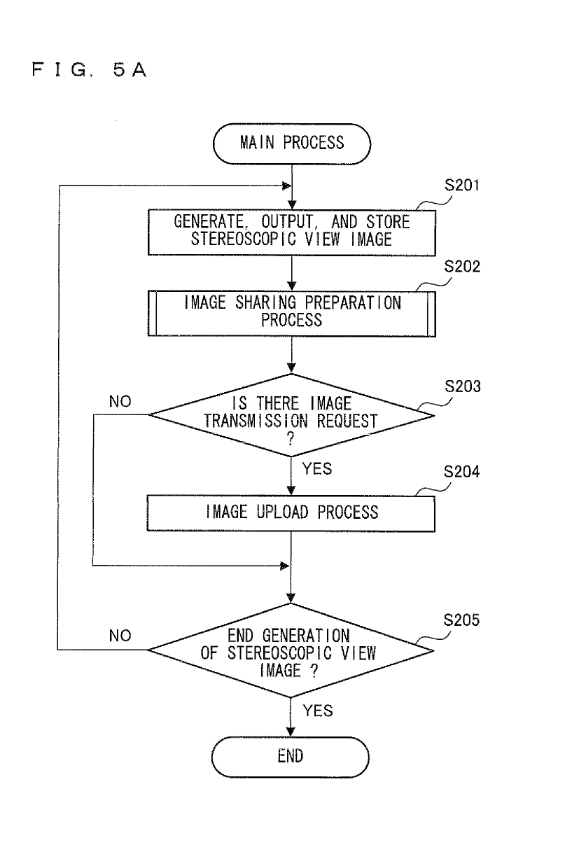

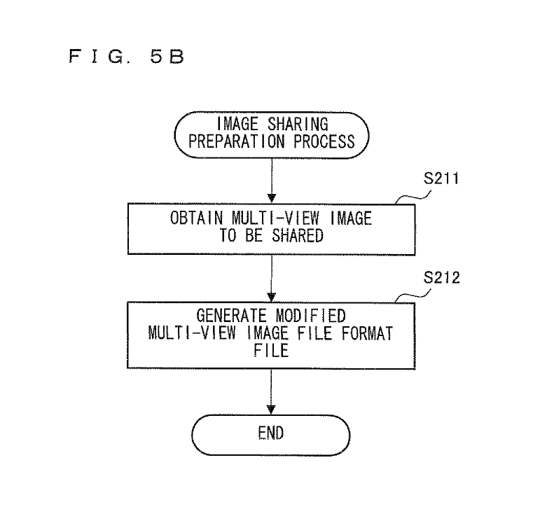

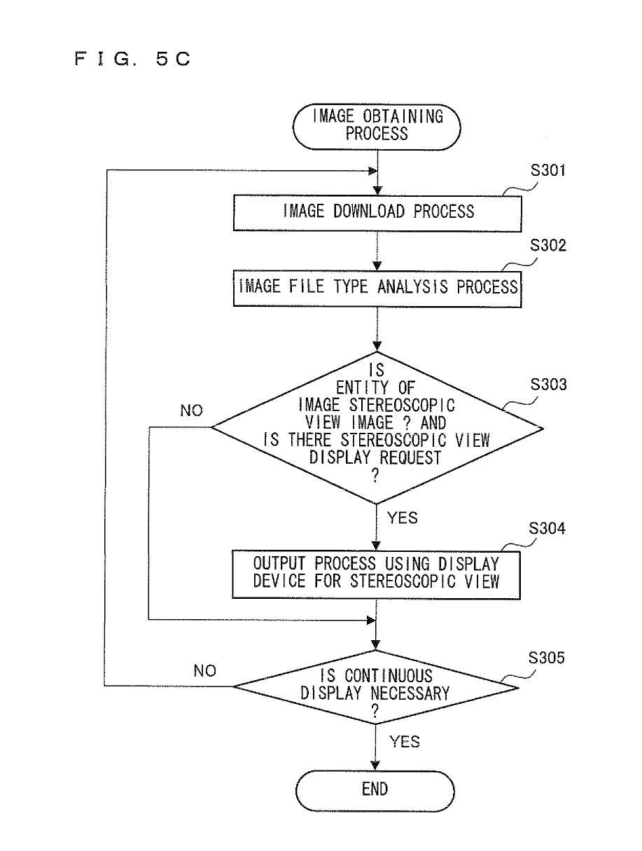

FIG. 5A is a flowchart illustrating an example of a main process performed on the basis of the information processing program 70 in the game apparatus 3 according to the exemplified embodiment of the present invention.

At step 201, the CPU 311 performs generation, output, and storing of a stereoscopic view image. Specifically, the CPU 311 generates a stereoscopic view image in accordance with a request from an application executed in the game apparatus 3 and an operation performed by the user. As described above, the game apparatus 3 has the outer imaging section 23a for a left eye and the outer imaging section 23b for a right eye that can serve as a stereo camera. The game apparatus 3 can execute a program that generates a stereoscopic view image taken by the stereo camera (an image group in which a binocular disparity is reflected). The game apparatus 3 can store the generated stereoscopic view image as a file of a predetermined format (e.g., a multi-picture format). Alternatively, the CPU 311 may generate a stereoscopic view image by storing, as a stereoscopically visible screen shot, a stereoscopically visible game image displayed on the upper LCD 22.

At step 202, the CPU 311 performs a preparation process for uploading a multi-view image file format file (e.g., a stereoscopic view image file) to the web server 4. Specifically, the CPU 311 performs a series of processes shown in FIG. 5B. FIG. 5B is a flowchart illustrating an exemplified image sharing preparation process.

At step 211 in FIG. 5B, the CPU 311 selects and obtains a multi-view image (a stereoscopic view image in this example) that can be uploaded to the web server 4 and shared. This image selection is performed as appropriate in accordance with a previously-provided setting, an input performed by the user, or a request from another program. The CPU 311 obtains a image file corresponding to the image selected as a processing target, from a storage area (e.g., the main memory 32) of the game apparatus 3. For example, the file format of the selected stereoscopic view image file (e.g., stereoscopic view images 1 to n in FIG. 4) is, for example, a multi-picture format.

At step 212, the CPU 311 generates a file that is compliant with the multi-view image file format (the multi-picture format in this example) but has the extension of its filename modified from its original one to an extension corresponding to JPEG (.JPG). At that time, the CPU 311 may change the file name of the original multi-picture format file, but generate a copy of the multi-picture format file, changes the file name of the copied multi-picture format file, and stores the file as a modified stereoscopic view image file (e.g., modified stereoscopic view images 1 to n (FIG. 4)). Then, the CPU 311 ends the image sharing preparation process and proceeds to a process at step 203 in FIG. 5A.

At step 203, the CPU 311 determines whether or not there is a request of image transmission to the web server 4. Specifically, the CPU 311 determines whether or not there is a request made by a user input or a request from a predetermined program executed in the game apparatus 3, which request designates an image file to be transmitted to the web server 4, When there is a request of image transmission (YES at step 203), the CPU 311 performs a process at 204 on the designated image file. On the other hand, when there is no request of image transmission (NO at step 203), the CPU 311 skips the process at step 204 and proceeds to a process at step 205.

At step 204, the CPU 311 performs an image upload process. Specifically, the CPU 311 uploads the modified stereoscopic view image file to the web server 4. At that time, the CPU 311 can upload the modified stereoscopic view image file to the web server 4 on the basis of the same protocol as that for transmitting a PEG file corresponding to general still image data.

At step 205, the CPU 311 determines whether or not to end generation of a stereoscopic view image. When not ending the generation, the CPU 311 returns to the process at step 201.

(Download from Web Server 4 to Game Apparatus 3)

A process of the CPU 311 processing an image file downloaded from the web server 4 as indicated by the reference character DW1 in FIG. 1 will be described with reference to FIG. 5C. FIG. 5C is a flowchart illustrating an example of a process performed when the game apparatus 3 (e.g., the game apparatus 3a or 3b) obtains an image file from the web server 4.

At step 301, the CPU 311 receives an image file from the web server 4. Specifically, for example, the CPU 311 can download an image file provided by the web server 4, in accordance with a request from the game apparatus 3. More specifically, for example, the web browser 71 of the game apparatus 3 accesses a web site provided by the web server 4, selects an image desired by the user from an image list that is provided on the site and that includes thumbnails, and downloads an image file of the selected image.

At step 302, the CPU 311 performs an image file type analysis process on the downloaded image file. Specifically, the CPU 311 determines whether the image file downloaded by the CPU 311 is a modified multi-view image file format file (e.g., a modified stereoscopic view image file) or a planar view image file.

Specifically, for example, the CPU 311 does not determine whether or not the downloaded image file is a modified multi-view image file format file on the basis of its extension, and determines whether or not the downloaded image file is a modified stereoscopic view image file (e.g., an image file of a multi-picture format as an entity other than the file name), from other information included in the downloaded image file.

As a more specific example, the case where the game apparatus 3 downloads an image file will be described. The game apparatus 3 regards an image file downloaded from the web server 4 as a multi-picture format file, and starts analysis. Then, in one example, the game apparatus 3 can determine whether or not the image file includes any individual image in addition to the first individual image in a multi-picture format. By so doing, the game apparatus 3b can determine whether or not the downloaded image file is a multi-picture format file as an entity. In another example, the game apparatus 3b reads out information in an area of additional information (e.g., individual image type management information or the like) of a multi-picture format in the downloaded image file, and can determine whether or not the image file includes a multi-view image, from this information. When the game apparatus 3b determines, from the obtained information, that information of a multi-view image (e.g., a stereoscopic view image) is included in the file that is a processing target, the game apparatus 3b can determine that the image file that is the processing target is a modified multi-view image file format file (a modified stereoscopic view image file in this example).

At step 303, the CPU 311 determines whether or not the entity of the image is a multi-view image (a stereoscopic view image in this case) and there is a request of stereoscopic display. Specifically, when the downloaded image file is a modified multi-view image file format file (in the determination at step 302) and there is a request of stereoscopic display (e.g., a user's input) (YES at step 303), the CPU 311 proceeds to a process at step 304. On the other hand, when these conditions are not met (NO at step 303), the CPU 311 does not perform the process at step 304, and proceeds to a process at step 305. It should be noted that when the downloaded image file is a planar view image file (an image file of a JPEG format) and there is a request of stereoscopic display, the CPU 311 may perform a process of displaying an image of the planar view image file on the display device of the game apparatus 3, before proceeding to step 305.

At step 304, the CPU 311 performs a process of outputting the stereoscopic view image to a display device for stereoscopic view. Specifically, the CPU 311 displays images of the stereoscopic view image file that is the processing target, on the upper LCD 22. On the upper LCD 22, an image for a left eye and an image for a right eye are displayed by using the substantially same display area. As described above, the upper LCD 22 is a parallax barrier type display.

At step 305, the CPU 311 determines whether not to it is unnecessary to continuously display stereoscopic view images. Specifically, the CPU 311 can determine end of the process in this flowchart in accordance with whether or not there is a request to continuously download image files and display the images. In other words, when it is necessary to continue this process (NO at step 305), the CPU 311 returns to the process at step 301 to perform a process of receiving a new image file in accordance with a request made by a user's input or the like. On the other hand, when it is unnecessary to continue this process (YES at step 305), the CPU 311 ends the process illustrated in this flowchart.

It should be noted that when the CPU 311 downloads a modified stereoscopic view image file, the CPU 311 can typically perform the following storage process on the modified stereoscopic view image file. The CPU 311 performs a process of changing the extension of the modified stereoscopic view image file from an extension for a planar view image format file (e.g., .JPG) to an extension for a multi-view image format file (i.e., .MPO). Thus, the file obtained as the downloaded modified stereoscopic view image file via the server can also be handled as a general stereoscopic view image file later. Then, for example, when such a general stereoscopic view image file is stored in a detachable storage medium, a stereoscopic view image can be transferred via the storage medium to another apparatus that can provide a stereoscopic view.

(Other Respects)

In the embodiment described above, a stereoscopic view image that can be reproduced on a display using a general parallax barrier method is generated as a method of reproducing a binocular disparity. However, a method of performing stereoscopic display is not limited to the parallax barrier method. For example, as a method of performing stereoscopic display, a so-called integral method may be used. In other words, as a method of reproducing a binocular disparity, an image in which a disparity is reflected may be displayed by using a principle of reproducing, on a display device, light reflected by an object. In a general liquid crystal display, three sub-pixels of RGB constitute one pixel. However, the integral method uses another configuration. For example, one pixel in video display is constituted of 27 sub-pixels. Then, the display device emits nine video images in which disparity information is reflected, as light having a plurality of directions (nine directions in the above example) by using a specially-shaped lens. Thus, the pixel group viewed through the above lens projects video images that are slightly differently viewed by right and left eyes, whereby a binocular disparity can occur.

In this example, the nine video images are used. When the nine video images are handled in a multi-view image file format that supports multi-view images, image files supporting the above integral method can also be used in modifications of the aforementioned exemplified embodiment that can be devised without departing from the scope of the present invention, similarly as in the aforementioned exemplified embodiment of the present invention concerning a stereoscopic view image.

In the exemplified embodiment described above, the information processing program 70 is used with the game apparatus 3. However, in another embodiment, the information processing program of the present invention may be used with any information processing apparatus or any information processing system (e.g., a PDA (Personal Digital Assistant), a mobile phone, a personal computer, or a camera).

In addition, in the exemplified embodiment described above, the information processing program is executed in game processing by using only one apparatus (game apparatus 3). However, in another embodiment, a plurality of information processing apparatuses, included in an image display system, that can communicate with each other may share the execution of the information processing program.

It should be noted that in the case where the information processing program and the like of the present invention are used on a general-purpose platform, the information processing program may be provided under the condition that a standard program module provided on the platform is used. It should be understood that even if a function corresponding to such a module as described above is excluded from the information processing program, the resultant information processing program substantially corresponds to the original information processing program as long as the module complements the excluded function.

While the invention has been described in detail, the foregoing description is in all aspects illustrative and not restrictive. It is understood that numerous other modifications and variations can be devised without departing from the scope of the invention. It should be understood that the scope of the present invention is interpreted only by the scope of the claims. It is also understood that, from the description of specific embodiments of the present invention, the one skilled in the art can easily implement the present invention in the equivalent range based on the description of the present invention and on the common technological knowledge. Further, it should be understood that terms used in the present specification have meanings generally used in the art concerned unless otherwise specified. Therefore, unless otherwise defined, all the jargon and technical terms have the same meanings as those generally understood by one skilled in the art of the present invention. In the event of any conflict, the present specification (including meanings defined herein) has priority.

What is claimed is:

1. An information processing system comprising a server for managing image files of a planar view image file format and a plurality of first information processing apparatuses each capable of transmitting/receiving an image file via the server,
at least one of the first information processing apparatuses comprising:
first transmission means for modifying metadata of an image file of a multi-view image file format which contains a multi-view image, to metadata of an image file of a planar view image file format, and transmitting the image file to the server, and
at least one of the first information processing apparatuses comprising:
first display control means for, when an image file of the planar view image file format that is received from the server contains a multi-view image, performing multi-view display on a first display device by using the multi-view image.

2. The information processing system according to claim 1, wherein the first transmission means changes an extension of the image file in the metadata of the image file of the multi-view image file format to an extension for the planar view image file format, and transmits the image file to the server.

3. The information processing system according to claim 1, wherein the multi-view image file format is such a format that when the metadata of the image file of the multi-view image file format is changed to the metadata of the planar view image file format, an image among the multi-view image can be read out as a planar view image.

4. The information processing system according to claim 1, wherein
the multi-view image file format is a multi-picture format, and
the planar view image file format is a JPEG format.

5. The information processing system according to claim 1, further comprising a second information processing apparatus capable of transmitting/receiving an image file to/from the first information processing apparatuses via the server, wherein
the second information processing apparatus comprising:
second display control means for, even when an image file of the planar view image file format that is received from the server contains a multi-view image, performing planar-view display on a second display device by using an image among the multi-view image.

6. The information processing system according to claim 5, wherein
the second information processing apparatus further comprises:
second transmission means for transmitting an image file of the planar view image file format to the server, and
the server comprises:
storage means for accumulatively storing the image file of the planar view image file format transmitted by the first transmission means of the first information processing apparatus and the image file of the planar view image file format transmitted by the second transmission means of the second information processing apparatus; and
third transmission means for transmitting the image files stored in the storage means to the first information processing apparatus and the second information processing apparatus.

7. The information processing system according to claim 1, wherein the first information processing apparatus further comprises storing means for, when an image file of the planar view image file format that is received from the server contains a multi-view image, modifying metadata of the image file to metadata of the multi-view image file format and storing the image file.

8. The information processing system according to claim 1, wherein the server further comprises image processing means for performing image processing on an image indicated by an image file of the planar view image file format.

9. The information processing system according to claim 1, wherein the first information processing apparatus further comprises imaging means capable of performing imaging from a plurality of perspectives to take a multi-view image.

10. The information processing system according to claim 9, wherein
the imaging means is capable of performing imaging from a single perspective to take a planar view image, and
the first transmission means transmits, to the server, an image file of the planar view image file format that indicates the planar view image taken by the imaging means.

11. The information processing system according to claim 1, wherein when an image file of the planar view image file format that is received from the server contains a multi-view image, the first display control means performs stereoscopic display on the first display device by using the multi-view image.

12. An information processing method performed between a server for managing image files of a planar view image file format and a plurality of first information processing apparatuses each capable of transmitting/receiving an image file via the server, the method comprising:
a first transmission step of at least one of the first information processing apparatuses modifying metadata of an image file of a multi-view image file format which contains a multi-view image, to metadata of an image file of a planar view image file format, and transmitting the image file to the server; and
a first display control step of, when an image file of the planar view image file format that is received from the server contains a multi-view image, at least one of the first information processing apparatuses performing multi-view display on a first display device by using the multi-view image.

13. A computer-readable storage medium having stored therein an information processing program executed by a computer included in an information processing system comprising a server for managing image files of a planar view image file format and a plurality of first information processing apparatuses each capable of transmitting/receiving an image file via the server,
the information processing program causing at least one of computers of the first information processing apparatuses to operate as:
first transmission means for modifying metadata of an image file of a multi-view image file format which contains a multi-view image, to metadata of an image file of a planar view image file format, and transmitting the image file to the server,
the information processing program causing at least one of the computers of the first information processing apparatuses to operate as:
first display control means for, when an image file of the planar view image file format that is received from the server contains a multi-view image, performing multi-view display on a first display device by using the multi-view image.

14. An information processing apparatus capable of transmitting/receiving an image file to/from another information processing apparatus via a server for managing image files of a planar view image file format, the information processing apparatus comprising:
first transmission means for modifying metadata of an image file of a multi-view image file format which contains a multi-view image, to metadata of an image file of a planar view image file format, and transmitting the image file to the server; and
first display control means for, when an image file of the planar view image file format that is received from the server contains a multi-view image, performing multi-view display on a first display device by using the multi-view image.

15. An information processing method performed by an information processing apparatuses capable of transmitting/receiving an image file to/from another information processing apparatus via a server for managing image files of a planar view image file format, the method comprising:
a first transmission step of modifying metadata of an image file of a multi-view image file format which contains a multi-view image, to metadata of an image file of a planar view image file format, and transmitting the image file to the server; and
a first display control step of, when an image file of the planar view image file format that is received from the server contains a multi-view image, performing multi-view display on a first display device by using the multi-view image.

16. An information processing system capable of transmitting/receiving an image file to/from another information processing system via a server for managing image files of a planar view image file format, the information processing system comprising:
first transmission means for modifying metadata of an image file of a multi-view image file format which contains a multi-view image, to metadata of an image file of a planar view image file format, and transmitting the image file to the server; and
first display control means for, when an image file of the planar view image file format that is received from the server contains a multi-view image, performing multi-view display on a first display device by using the multi-view image.

17. A computer-readable storage medium having stored therein an information processing program executed by a computer of an information processing apparatus capable of transmitting/receiving an image file to/from another information processing apparatus via a server for managing image files of a planar view image file format,
the information processing program causing the computer to operate as:
first transmission means for modifying metadata of an image file of a multi-view image file format which contains a multi-view image, to metadata of an image file of a planar view image file format, and transmitting the image file to the server; and
first display control means for, when an image file of the planar view image file format that is received from the server contains a multi-view image, performing multi-view display on a first display device by using the multi-view image.
